(19) United States
(12) Patent Application Publication
(10) Pub. No.: US 2018/0079495 A1
(43) Pub. Date: Mar. 22, 2018

(54) SYSTEMS AND METHODS FOR FORECASTING AND REDUCING THE OCCURRENCE OF TIRE OVERSPEED EVENTS DURING AIRCRAFT TAKEOFF AND LANDING

(71) Applicant: HONEYWELL INTERNATIONAL INC., Morris Plains, NJ (US)

(72) Inventors: Srihari Jayathirtha, Bangalore (IN); Kalimulla Khan, Bangalore (IN); Mohammed Ibrahim Mohideen, Bangalore (IN)

(73) Assignee: HONEYWELL INTERNATIONAL INC., Morris Plains, NJ (US)

(21) Appl. No.: 15/268,035

(22) Filed: Sep. 16, 2016

(51) Int. Cl. B64C 25/40; B64D 43/00

(52) U.S. Cl. CPC B64C 25/405; B64D 43/00

(57) ABSTRACT

Avionic systems and methods are provided for forecasting and reducing the likelihood of tire overspeed events during aircraft (A/C) runway procedures, such as takeoff and landing procedures. In one embodiment, the avionic system includes a controller coupled to at least one runway procedure data source, such as pilot input interface, a flight management system, atmospheric data sensors, or a navigational database. During operation, the controller receives runway procedure data from the runway procedure data sources pertaining to a planned runway procedure for the ownship A/C. The controller utilizes the runway procedure data to project at least one maximum tire speed during the planned runway procedure (TS_{MAX}_{_}_{PROJECTED}), which is then compared to a maximum speed limit of the A/C tires (TS_{LIMIT}). If TS_{MAX}_{_}_{PROJECTED} exceeds TS_{LIMIT}, the controller generates an alert or notification indicating the probable occurrence of a tire overspeed event during the planned runway procedure.

### TECHNICAL FIELD

The following disclosure relates generally to avionic systems and, more particularly, to avionic systems and methods for forecasting and reducing the likelihood of tire overspeed events during aircraft takeoff and landing.

### BACKGROUND

Aircraft (A/C) are commonly equipped with tires having maximum speed ratings. In certain instances, particularly during takeoff and landing, the maximum speed rating of the A/C tires may be exceeded (an occurrence referred to herein as a “tire overspeed event”). Tire overspeed events are often relatively brief and limited in severity and, thus, pose little risk of damaging the A/C tires. However, when a tire overspeed event is more pronounced in severity or duration, or when A/C tires are subject to repeated overspeed events, the structural integrity of the A/C tires may become compromised and the likelihood of tread loss may increase. It is thus desirable to minimize the occurrence of tire overspeed events to the extent possible. This can be difficult in practice, however, due to the dynamic and multidimensional nature of takeoff and landing. Consider, for example, an A/C takeoff procedure during which relatively high V-speed are required as a result of hot weather conditions, heavy A/C loads, high airport altitude, or other such factors. Under such circumstances, a tire overspeed event can readily occur should the relationship between the A/C groundspeed and airspeed abruptly change due to, for example, a sudden variance in tailwind conditions, delay in initiating A/C rotation, or a slow A/C rotation rate. Similarly, during landing, a tire overspeed event may occur when the A/C ground speed is relatively high at touchdown and/or tailwind conditions rapidly change. The wholesale prevention of tire overspeed events is thus difficult, if not impossible to achieve utilizing current systems and practices. As a related issue, relatively few, if any avionic systems currently provide adequate notification of the occurrence and severity of tire overspeed events. Consequently, appropriate maintenance actions may not be scheduled and performed following a tire overspeed event.

### BRIEF SUMMARY

Avionic systems are provided for forecasting and reducing the likelihood of tire overspeed events during aircraft (A/C) runway procedures, such as takeoff and landing procedures. Embodiments of the avionic system may be deployed onboard an ownship A/C having A/C tires. In one embodiment, the avionic system includes a controller coupled to at least one runway procedure data source, such as a pilot input interface (e.g., a keypad on a Flight Management System (FMS)), sensors onboard the A/C (e.g., atmospheric data sensors), and one or more databases, such as a navigational database, a terrain database, a runway database, and/or a historical trend database. During operation of the avionic system, the controller receives runway procedure data from the runway procedure data source(s) pertaining to a planned runway procedure to be carried-out by the ownship A/C. The controller utilizes the runway procedure data to project at least one maximum tire speed during the planned runway procedure (TS_{MAX}_{_}_{PROJECTED}), which is then compared to a maximum speed limit of the A/C tires (TS_{LIMIT}). If TS_{MAX}_{_}_{PROJECTED} exceeds TS_{LIMIT}, the controller generates a notification (e.g., a visual alert) indicating the probable occurrence of a tire overspeed during the planned runway procedure. The pilot may then modify one or more aspects of the planned runway procedure to preempt or decrease the likelihood of the tire overspeed event prior to completing the runway procedure.

In another embodiment, the avionic system includes a display device, a pilot input interface, and a controller operably coupled to the display device and to the pilot input interface. The controller is configured to: (i) receive pilot-entered data via the pilot input interface describing planned runway procedures for the ownship A/C; (ii) project maximum tire speeds of the A/C tires during the planned runway procedures utilizing the pilot-entered data; and (iii) selectively generate visual notifications on the display device indicative of forecasted tire overspeed events based, at least in part, on the projected maximum tire speeds and the maximum speed limit of the A/C tires. In certain implementations, the pilot input interface may include or be included within an FMS, and the controller may receive the pilot-entered data as takeoff and landing data entered into the FMS. Additionally or alternatively, the controller may selectively generate the visual notifications as visual alerts, such as text annunciations, which are graded or categorized based on a predicted likelihood of a forecasted tire overspeed event, a predicted severity of a forecasted tire overspeed events, or a combination thereof.

Methods for forecasting and reducing the likelihood of tire overspeed events during aircraft runway procedures are further provided. Embodiments of the method may be carried-out by the controller of an avionic system deployed onboard or otherwise associated with an A/C having A/C tires. In one embodiment, the method includes the step or process of receiving runway procedure data describing a planned runway procedure for the A/C. The runway procedure data is utilized to project a maximum tire speed during the planned runway procedure (TS_{MAX}_{_}_{PROJECTED}), which is then compared to a maximum speed limit of the A/C tires (TS_{LIMIT}). If TS_{MAX}_{_}_{PROJECTED} exceeds TS_{LIMIT}, a first alert is generated (e.g., as visual alert on a display screen of the avionic system) indicating that a tire overspeed event is predicted to occur during the planned runway procedure. In certain implementations, the method may also include determining at least a first suggested corrective action reducing TS_{MAX}_{_}_{PROJECTED} if TS_{MAX}_{_}_{PROJECTED} exceeds TS_{LIMIT}, and presenting the first suggested corrective action on a display screen of the avionic system when generating the first alert. Additionally or alternatively, the first alert may be generated to indicate a forecasted severity of the predicted tire overspeed event.

### BRIEF DESCRIPTION OF THE DRAWINGS

At least one example of the present invention will hereinafter be described in conjunction with the following figures, wherein like numerals denote like elements, and:

FIG. 1 is a block diagram of an avionic system onboard an ownship aircraft and illustrated in accordance with an exemplary and non-limiting embodiment of the present disclosure;

FIG. 2 is a flowchart illustrating a prognostic tire overspeed algorithm that may be carried-out by the avionic system of FIG. 1 to predict the likelihood of tire overspeed events during takeoff and/or landing of the ownship aircraft, as illustrated in accordance with an exemplary and non-limiting embodiment of the present disclosure;

FIG. 3 is a screenshot of a top-down or horizontal navigation display including a tire overspeed warning alert, which can be generated by the avionic system shown in FIG. 1 when determining that a tire overspeed event is predicted to occur;

FIG. 4 is a screenshot of a lateral or vertical navigation display including a tire overspeed caution alert, which be generated by the avionic system shown in FIG. 1 when determining that the likelihood of a tire overspeed event is undesirably high; and

FIGS. 5 and 6 are screenshot of first and second tire speed status graphics, respectively, which visually express maximum tire speed ratings and other parameters relating to tire speed during a runway procedure, as illustrated in accordance with further exemplary embodiments of the present disclosure.

### DETAILED DESCRIPTION

The following Detailed Description is merely exemplary in nature and is not intended to limit the invention or the application and uses of the invention. The term “exemplary,” as appearing throughout this document, is synonymous with the term “example” and is utilized repeatedly below to emphasize that the description appearing in the following section merely provides multiple non-limiting examples of the invention and should not be construed to restrict the scope of the invention, as set-out in the Claims, in any respect. Furthermore, terms such as “comprise,” “include,” “have,” and variations thereof are utilized herein to denote non-exclusive inclusions. Such terms may thus be utilized in describing processes, articles, apparatuses, and the like that include one or more named steps or elements, but may further include additional unnamed steps or elements. Finally, the term “pilot,” as appearing herein, is defined to encompass all members of a flight crew.

Avionic systems and methods are provided for forecasting and reducing the likelihood of tire overspeed events during takeoff and landing. In certain embodiments, an avionic system onboard an aircraft (referred to herein as the “ownship A/C”) carries-out a prognostic tire overspeed algorithm to project or forecast at least one maximum tire speed (TS_{MAX}_{_}_{PROJECTED}) during a planned runway procedure, such as a planned takeoff or landing procedure. The avionic system further establishes a maximum speed rating of the A/C tires (TS_{LIMIT}) by, for example, recalling TS_{LIMIT} from a stored Aircraft Flight Manual (AFM) or by receiving pilot input data specifying TS_{LIMIT}. The avionic system then determines the probability of the occurrence of a tire overspeed event as a function of TS_{MAX}_{_}_{PROJECTED} and TS_{LIMIT}. If the probability of a tire overspeed event is undesirably high, the avionic system notifies the pilot by, for example, generating one or more visual alerts on a cockpit display, such as a Primary Flight Display (PFD) or a navigational display. In certain embodiments, the visual alerts may be graded or categorized and may increase in urgency (e.g., as conveyed by visual coding, such as color coding) as the forecasted likelihood and/or potential severity of the predicted tire overspeed event increases. When the probability of a tire overspeed event is undesirably high, the avionic system may also provide suggested corrective actions for reducing TS_{MAX}_{_}_{PROJECTED}. In this manner, the avionic system affords the pilot an opportunity to revise the parameters of the planned takeoff or landing procedure and thereby avoid (or at least reduce the likelihood of) impending tire overspeed events. The frequency and severity of tire overspeed events may be reduced as a result thereby better preserving the structural integrity of the A/C tires, reducing maintenance costs, and enhancing overall safety.

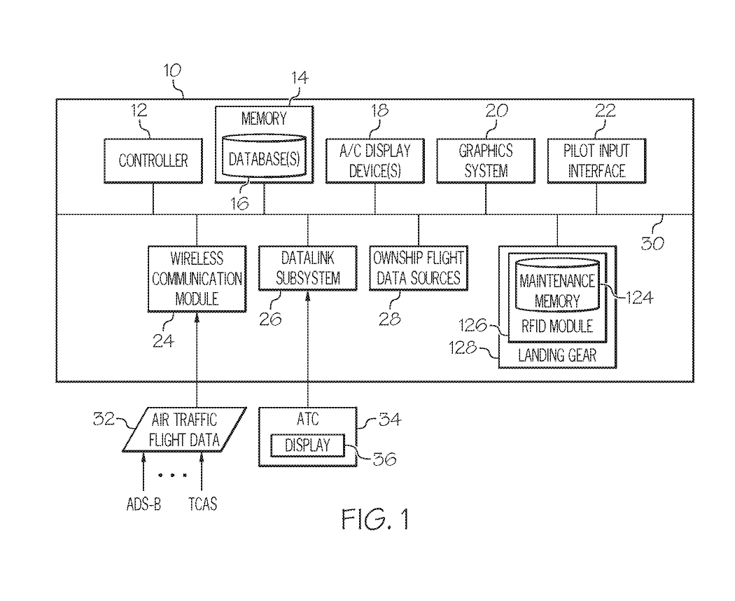

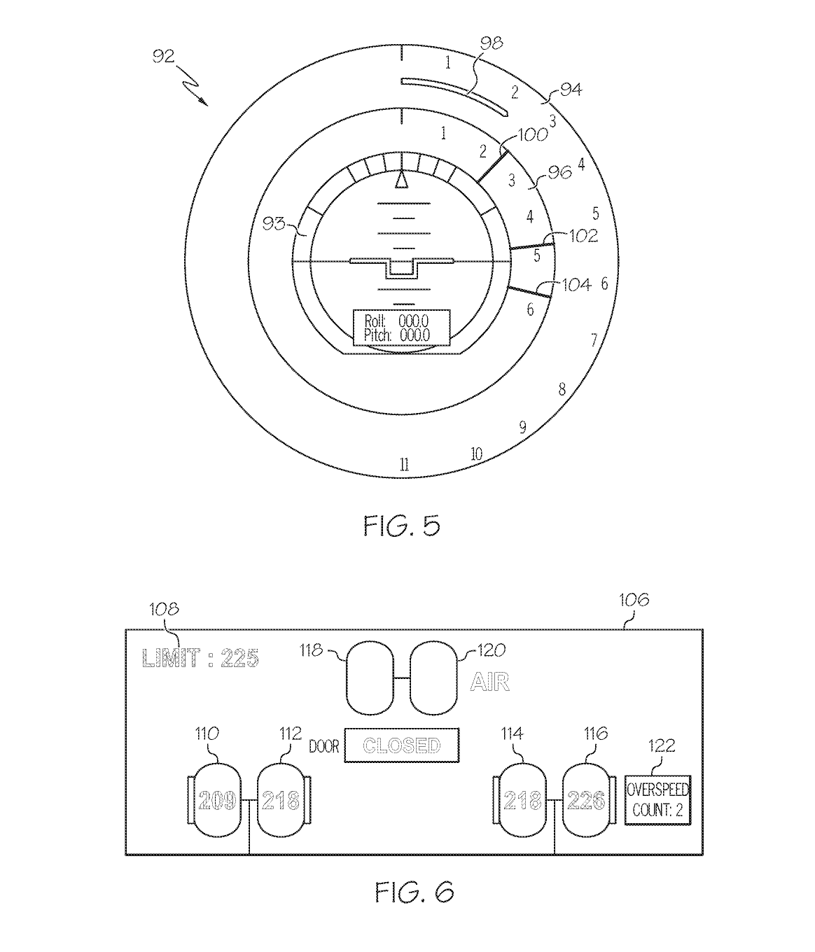

In certain embodiments, the avionic system may also present information relating to tire overspeed events and tire speed, generally, prior to and during runway procedures. In this regard, a tire speed status graphic can be generated on a display screen visually denoting TS_{LIMIT} and other tire speed-related parameters, such as an actual tire speed (TS_{ACTUAL}) and A/C rotation rate limits. Such parameters can be computed on an iterative or dynamic basis utilizing real time data to enhance the situational awareness of the pilot to aid in the early detection and avoidance of tire overspeed events. Furthermore, if a tire overspeed event should occur, this can be indicated on the tire speed status graphic along with information pertaining to the tire overspeed event, such as the duration and/or severity of the tire overspeed event. Additionally or alternatively, such information regarding the occurrence of tire overspeed events can be automatically transmitted to a remote source for maintenance scheduling purposes and/or logged in a memory. In one embodiment, the memory may be included in a Central Maintenance Computer (CMM) onboard the ownship A/C. In another embodiment, the memory may be included in an Radio Frequency Identification (RFID) module, which is mounted to or adjacent the landing gear to which the A/C tires are fitted and which is readily accessible to maintenance personnel equipped with an RFID scanner. Examples of such tire speed status graphics are described more fully below in conjunction with FIGS. 5 and 6. First, however, additional description of an exemplary avionic system and prognostic tire overspeed algorithm will be described in conjunction with FIGS. 1-4.

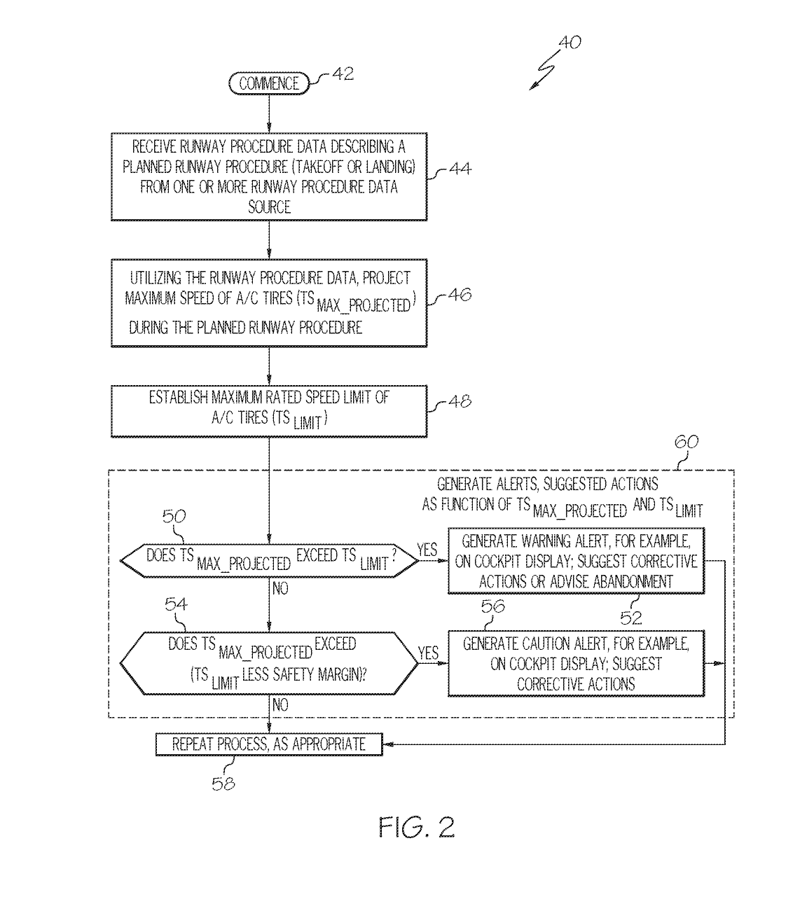

FIG. 1 sets-forth a block diagram of an avionic system 10 suitable for carry-out embodiments of the prognostic tire overspeed algorithm, such as algorithm 40 described below in conjunction with FIG. 2. Avionic system 10 includes the following components, many or all of which may be comprised of multiple devices, systems, or elements: (i) a controller 12; (ii) a memory 14; (iii) one or more cockpit display devices 18; (iv) a graphics system 20; (v) a pilot input interface 22; (vi) a wireless communication module 24; (vii) a datalink subsystem 26; and (viii) one or more sources of flight status data pertaining to the A/C (referred to herein as “ownship flight data sources 28”). The foregoing components of avionic system 10 are operatively coupled by an interconnection architecture 30 enabling the transmission of data, command signals, and operating power. Although avionic system 10 is schematically illustrated in FIG. 1 as a single unit, the individual elements and components of avionic system 10 can be implemented in a distributed manner using any number of physically-distinct and operatively-interconnected pieces of hardware or equipment.

Controller 12 may comprise, or be associated with, any suitable number of additional conventional electronic components including, but not limited to, various combinations of microprocessors, flight control computers, navigational equipment, memories, power supplies, storage devices, interface cards, and other standard components known in the art. Furthermore, controller 12 may include, or cooperate with, any number of software programs (e.g., avionic display programs) or instructions designed to carry-out the various methods, process tasks, calculations, and control/display functions described below. During operation of avionic system 10, controller 12 obtains and processes current data indicative of the likelihood of tire overspeed events during planned runway procedures. If determining that a tire overspeed event is undesirably probable, controller 12 may produce a visual alert or notification on cockpit display device(s) 18, as described more fully below. In certain embodiments, controller 12 may also present suggested corrective actions on display devices 18 and/or may provide additional graphics visually expressing the likelihood of a tire overspeed event, whether a tire overspeed event has occurred, the severity of a predicted or actual tire overspeed event, and/or other parameters relating to tire overspeed events.

Memory 14 can be external to and operatively coupled to controller 12 or, instead, in integrated into controller 12. In one embodiment, controller 12 and memory 14 reside in an Application Specific Integrated Circuit (“ASIC”). Memory 14 may store data, such as various software or firmware, supporting operation of controller 12 and other components included in avionic system 10, such as graphics system 20, wireless commination module 24, and the datalink subsystem 26. Additionally, as schematically indicated in FIG. 1, memory 14 may store one or more onboard databases 16. Onboard databases 16 can include a navigational database, a terrain database, a weather database, a historical trend database, and/or a runway database, such as an Enhanced Ground Proximity Warning System (“EGPWS”) runway database. Onboard databases 16 contain information pertaining to airports and runways useful in forecasting maximum tire speeds during takeoff and landing, such as runway lengths, topographies, and altitudes. Additionally, in certain implementations, memory 14 may store maximum rated tire speed limits associated with the A/C tires.

Controller 12 and graphics system 20 cooperate to display, render, or otherwise convey one or more graphical representations, synthetic displays, graphical icons, visual symbology, or images associated with operation of the ownship A/C on cockpit display device(s) 18. An embodiment of avionic system 10 may utilize existing graphics processing techniques and technologies in conjunction with graphics system 20. Graphics system 20 is suitably configured to support well-known graphics technologies. Cockpit display device(s) 18 may comprise any image-generating device or devices capable of producing one or more navigation displays of the type described below. As a point of emphasis, the term “cockpit display device” encompasses display devices (image-generating devices) fixed to the A/C cockpit, as well as Electronic Flight Bags (“EFBs”) and other portable display devices that may be carried by a pilot into the cockpit of an A/C and perform the below-described functions.

In an exemplary embodiment, wireless communication module 24 is configured to support data communication between the ownship A/C and one or more remote systems. Wireless communication module 24 allows reception of current air traffic data 32 of other A/C within the proximity of the ownship A/C. For example, wireless communication module 24 may be configured for compatibility with Automatic Dependent Surveillance Broadcast (“ADS-B”) technology, with Traffic and Collision Avoidance System (“TCAS”) technology, and/or with similar technologies. In certain implementations, wireless communication module 24 may receive ADS-B and/or TCAS data indicating the current surface conditions or braking action of a runway recently utilized by another A/C. Finally, datalink subsystem 26 enables wireless bi-directional communication between the ownship A/C and an ATC system 34, which includes an ATC display 36. Datalink subsystem 26 may be utilized to provide ATC data to the ownship A/C and/or to send information from the ownship A/C to ATC in compliance with known standards and specifications.

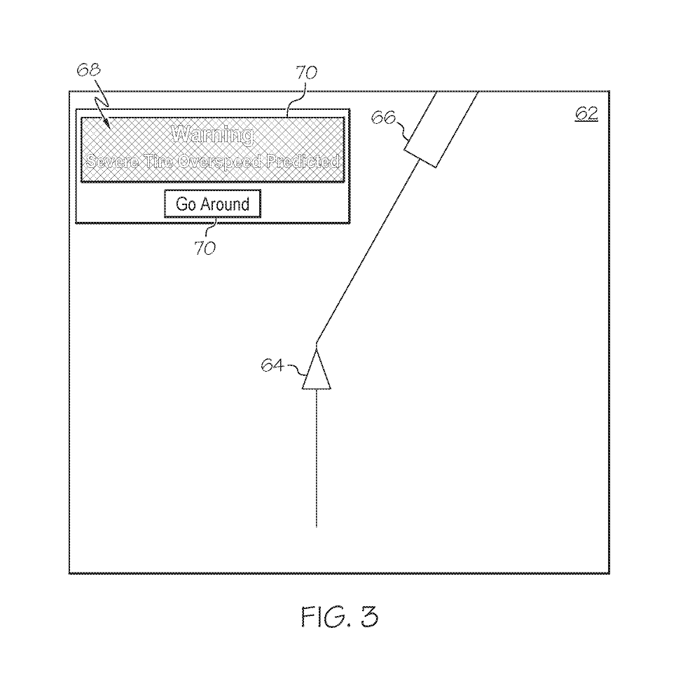

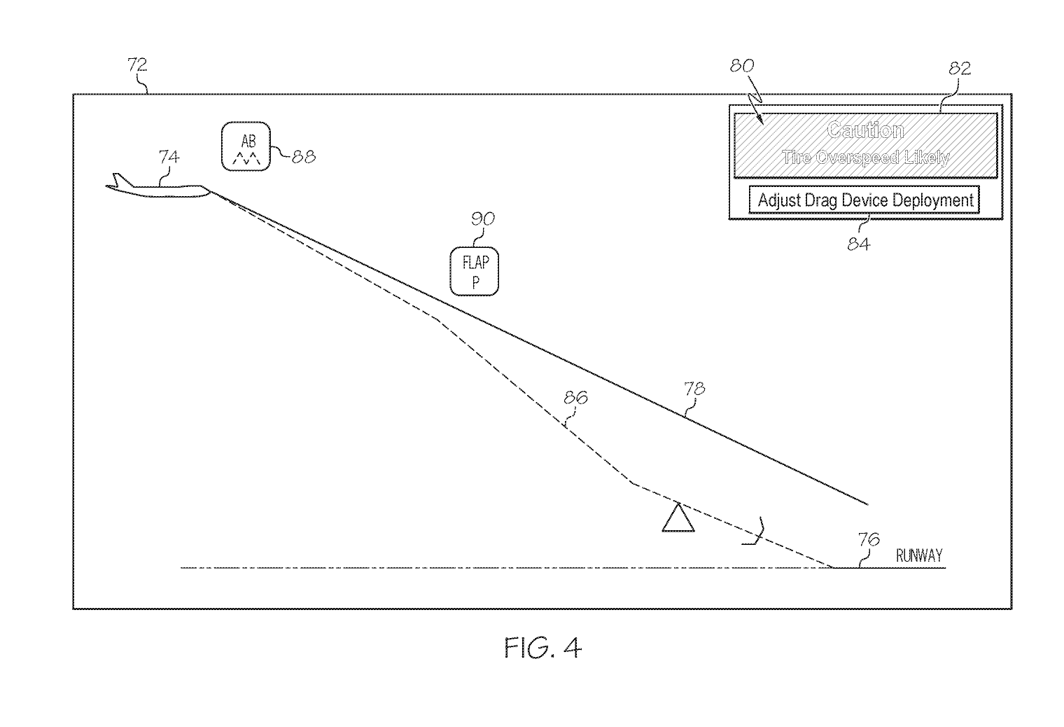

With continued reference to FIG. 1, ownship flight data sources 28 generate, measure, and/or provide different types of data related to the operational status of the ownship A/C, the environment in which the ownship A/C is operating, flight parameters, and the like. Ownship flight data sources 28 may also include other systems or subsystems commonly deployed onboard A/C, such as a Flight Management System (“FMS”), an Inertial Reference System (“IRS”), and/or an Attitude Heading Reference System (“AHRS”). Data provided by ownship flight data sources 28 may include, without limitation: airspeed data; groundspeed data; altitude data; attitude data including pitch data and roll data; yaw data; geographic position data, such as Global Positioning System (“GPS”) data; gross A/C weight; time/date information; heading information; atmospheric conditions; flight path data; track data; radar altitude; geometric altitude data; wind speed data; wind direction data; fuel consumption; and the like. Avionic system 10 may utilize flight status data of the ownship A/C when rendering the navigation displays described below in conjunction with FIGS. 3 and 4. Avionic system 10 may also consider input data received via pilot input interface 22 when performing the below-described functions. In this regard, pilot input interface 22 can include any number and type of input devices suitable for receiving pilot input, which may be distributed throughout the cockpit of an A/C and possibly included in other systems or subsystems. In one embodiment, pilot input interface 22 assumes the form of or includes the alphanumeric keypad of an FMS.

FIG. 2 is a flowchart illustrating a prognostic tire overspeed algorithm 40 for predicting the likelihood of a tire overspeed event during a planned runway procedure, as illustrated in accordance with an exemplary embodiment of the present disclosure. Prognostic tire overspeed algorithm 40 will often be performed by an avionic system deployed onboard the A/C intended to carry-out the planned runway procedure. Accordingly, prognostic tire overspeed algorithm 40 is described below as carried-out by controller 12 of avionic system 10 (FIG. 1). It is noted, however, that prognostic tire overspeed algorithm 40 can be performed off-board the ownship A/C in certain implementations by an air traffic authority or another remote entity. For example, in certain instances, ATC 34 can perform prognostic tire overspeed algorithm 40 prior to authorizing a requested clearance for a planned runway procedure (takeoff or landing) of the ownship A/C. In such instances, visual alerts of forecasted tire overspeed events similar to the visual alerts described below in conjunction with FIGS. 3 and 4 can be generated, as appropriate, on display 36 of ATC 34.

Prognostic tire overspeed algorithm 40 includes a number of process STEPS 42, 44, 46, 48, 50, 52, 54, 56, 58, with STEPS 50, 52, 54, 56 performed as part of a larger PROCESS BLOCK 60. STEPS 42, 44, 46, 48, 50, 52, 54, 56, 58 are each described, in turn, below. The following description notwithstanding, it is emphasized that the steps illustrated in FIG. 2 and described below are provided by way of example only. In alternative embodiments of prognostic tire overspeed algorithm 40, additional steps may be performed, certain steps may be omitted, and/or the illustrated steps may be performed in alterative sequences. Additionally, each step generically illustrated in FIG. 2 may entail any number of individual sub-processes or combination of sub-processes depending upon the manner in which prognostic tire overspeed algorithm 40 is implemented.

Prognostic tire overspeed algorithm 40 may commence (STEP 42, FIG. 2) when controller 12 (FIG. 1) determines that the ownship A/C is pending an upcoming runway procedure or when the ownship A/C is in the initial stages of a runway procedure. This may be indicated by pilot input data received via pilot input interface 22; e.g., during entry of data into an FMS included in ownship flight data sources 28 pertaining to takeoff or landing calculations. In another embodiment, controller 12 may initiate prognostic tire overspeed algorithm 40 when ATC clearance is requested or received to execute a particular takeoff or landing. As another possibility, prognostic tire overspeed algorithm 40 may commence in response to the receipt of pilot input requesting the performance of algorithm 40. As a still further possibility, prognostic tire overspeed algorithm 40 may commence during landing or during takeoff roll. After commencement, prognostic tire overspeed algorithm 40 may be performed iteratively to more accurately reflect, in real time or near real time, changes in dynamic conditions affecting tire speed, such as shifting surface wind conditions. For example, in the case of a takeoff procedure, controller 12 may initiate prognostic tire overspeed algorithm 40 prior to or during the takeoff roll and then interactively perform algorithm 40 until liftoff is achieved to reflect real time surface wind conditions and other such dynamic factors.

After prognostic tire overspeed algorithm 40 commences (STEP 42, FIG. 2), controller 12 gathers runway procedure data pertaining to a planned runway procedure for the ownship A/C (STEP 44, FIG. 2). Controller 12 receives the runway procedure data from one or more runway procedure data sources, which can include memory 14, pilot input interface 22, ownship flight data sources 28, and any other component of avionic system 10 (FIG. 1). Certain runway procedure data may also be wirelessly transmitted to avionic system 10 via wireless communication module 24 and/or datalink subsystem 26, in which case either of the aforementioned components may also be considered “runway procedure data source” in the context of the present document. Various different types of information may be contained in the runway procedure data, which may include various types of sensor data, pilot-entered parameters, and data extracted from onboard databases 16.

The runway procedure data gathered by controller 12 during STEP 44 of prognostic tire overspeed algorithm 40 may also include V-speeds and A/C parameters, which may be entered into avionic system 10 via pilot input interface 22, wirelessly transmitted to avionic system 10 via wireless communication module 24 or datalink subsystem 26, or extracted from ownship flight data sources 28. Ownship flight data sources 28, for example, may include various onboard sensors that supply real time data describing atmospheric conditions, such as wind conditions, moisture levels, altitudes, air densities, temperatures, and the like. Ownship flight data sources 28 may also provide information pertaining to the current A/C configuration, which can include the A/C gross weight at the time of takeoff or landing, center of gravity, engine thrust ratings, and bleed status, to list but a few examples. Ownship flight data sources 28 will often include one or more systems or subsystems, such as an FMS. For example, the runway procedure data may include Takeoff and Landing Data (commonly referred to as “TOLD” data) entered into the FMS by a pilot, which is then extracted and supplied to controller 12 during STEP 44. Still further data that may be gathered by controller 12 during STEP 44 of prognostic tire overspeed algorithm 40 includes runway characteristics pertaining to the runway on which the planned runway procedure is to be performed (referred to herein as the “designated runway”). For example, usable runway length, geometry, altitude, and other such characteristics of the designated runway can be recalled from onboard databases 16 during STEP 44. Finally, still further runway procedure data may be received wirelessly via communication module 24 or datalink subsystem 26, such as information pertaining to the current surface conditions of the designated runway and newly-implemented runway usage restrictions.

Next, during STEP 46 of prognostic tire overspeed algorithm 40 (FIG. 2), controller 12 utilizes the previously-gathered runway procedure data to forecast a maximum speed of one or more A/C tires during the planned runway procedure (TS_{MAX}_{_}_{PROJECTED}). In the case of a landing procedure, controller 12 may utilize any combination of the above-described criteria to calculate TS_{MAX}_{_}_{PROJECTED}, which will typically be equivalent to the tire speed at touchdown. Similarly, in the case of a takeoff procedure, controller 12 may calculate TS_{MAX}_{_}_{PROJECTED}, which will typically be equivalent to the tire speed at liftoff. Controller 12 may also calculate TS_{MAX}_{_}_{PROJECTED} for landing utilizing a standard rotation rate. The standard rotation rate may be recalled from memory 14, entered into avionic system 10 by a pilot utilizing pilot input interface 22, or otherwise determined The standard rotation rate will vary between aircraft, but may be between about 2 to 6 degrees per second and, perhaps, between about 2 and 3 degrees per second in an embodiment. In certain implementations, historical trends may also be considered during STEP 46 of prognostic tire overspeed algorithm 40, as may be recalled from memory 14 or wirelessly transmitted to avionic system 10 from ATC 34 or another remote data source. When considered, the historical weather data (e.g., historical surface wind conditions) can be blended with current weather data to more accurately forecast TS_{MAX}_{_}_{PROJECTED} during the planned runway procedure. TS_{MAX}_{_}_{PROJECTED} may be calculated as a single value, such as 200 miles per hour (MPH) to provide an arbitrary example. Alternatively, TS_{MAX}_{_}_{PROJECTED} may be calculated as a probabilistic range, such as 200 MPH±10 MPH. In this latter case, TS_{MAX}_{_}_{PROJECTED} may be calculated under a range of probabilistic conditions, such as slow and excessive rotation rates, early rotation limits, and late rotation limits, which are computed based on the historic operational trend or based on appropriate pre-determined values.

Prior to, after, or concurrently with forecasting TS_{MAX}_{_}_{PROJECTED}, controller 12 establishes a maximum rated speed limit of one or more A/C tires (TS_{LIMIT}). In the case of prognostic tire overspeed algorithm 40, specifically, controller 12 establishes TS_{LIMIT} after determining TS_{MAX}_{_}_{PROJECTED}. In one embodiment, controller 12 may establish TS_{LIMIT} by recalling a maximum rated speed limit of the A/C tires from memory 14. For example, in certain embodiments, the rated speed limit of the A/C tires may be extracted from a digital AFM stored in memory 14. In other embodiments, controller 12 may determine TS_{LIMIT} utilizing a multidimensional lookup table correlating TS_{LIMIT} to different tire types, aircraft classes, or the like. As a still further possibility, TS_{LIMIT} may be entered into avionic system 10 via pilot input interface 22 or transmitted to avionic system 10 via datalink subsystem 26. TS_{LIMIT} may be between 200 and 300 MPH in many embodiments. In other embodiments, TS_{LIMIT} may be greater than or less than the aforementioned range.

With continued reference to FIG. 2, prognostic tire overspeed algorithm 40 next advances to PROCESS BLOCK 60. During PROCESS BLOCK 60, controller 12 determines whether predictive overspeed notifications are appropriately generated as a function of T_{MAX}_{_}_{PROJECTED} and T_{LIMIT}. If the probability of a tire overspeed event is undesirably high, controller 12 provides notification by, for example, generating a corresponding visual alert on a cockpit display screen. The visual alert may be graded or categorized and may increase in urgency (e.g., as conveyed by color coding) as the forecasted likelihood and potential severity of the predicted tire overspeed event increases. When the probability of a tire overspeed event is undesirably high, the avionic system may also provide suggested corrective actions for reducing TS_{MAX}_{_}_{PROJECTED}. The particular method by which controller 12 generates alerts and suggested corrective actions will vary amongst embodiments, as will the particular manner in which such alerts and corrective actions are presented to the pilot. A relatively simple example of one manner in which two different types of visual alerts (namely, a high level warning alert and a low level caution alert) can be generated is described below in conjunction with STEPS 50, 52, 54, 56 of prognostic tire overspeed algorithm 40 (FIG. 2). In further embodiments, prognostic tire overspeed algorithm 40 may generate non-graded alerts, audible alerts, further grades of alerts, and/or may otherwise differ from the below-described examples.

Turning STEP 50 of prognostic tire overspeed algorithm 40 (FIG. 2), controller 12 next determines whether a high level warning alert should be generated by, for example, directly comparing TS_{MAX}_{_}_{PROJECTED} to TS_{LIMIT}. If determining that TS_{MAX}_{_}_{PROJECTED} exceeds TS_{LIMIT}, controller 12 generates a corresponding audible and/or visual warning alert. For example, the predicted overspeed warning alert can be generated on a graphical cockpit display produced on cockpit display device 18. The cockpit display can be any display useful for presenting such an alert, such as a PFD or navigational display. Consider, for example, FIG. 3 depicting a horizontal navigation display 62 from a top-down or planform point of view (also commonly referred to as a “moving map” display). In the scenario depicted in FIG. 3, the ownship A/C (represented by symbol 64) is on final approach to land at a designated runway (represented by symbol 66). In accordance with STEPS 50, 52 of algorithm 40 (FIG. 2), controller 12 determined that TS_{MAX}_{_}_{PROJECTED} exceeds TS_{LIMIT} and then generated a predicted overspeed warning alert 68 on horizontal navigation display 62. In this particular example, overspeed warning alert 68 is presented as a text annunciation contained in a text box 70, which appears in the upper left corner of horizontal navigation display 62. To visually convey the relative urgency of overspeed warning alert 68, text box 70 is generated in accordance with a predetermined color coding scheme. In particular, as represented in FIG. 3 by a first type of cross-hatching, text box 70 may be shaded or filled with a pre-established warning color, such as red.

In embodiments of prognostic tire overspeed algorithm 40 (FIG. 2), controller 12 may also provide additional information describing the forecasted tire overspeed event when generating a visual alert on a cockpit display. For example, as further indicated in FIG. 3, controller 12 may generate overspeed warning alert 68 to specify a forecasted magnitude of the predicted tire overspeed event (here, the predicted tire overspeed event is labeled as “SEVERE”). Additionally or alternatively, controller 12 may provide: (i) at least one suggested modification to the planned runway procedure to reduce TS_{MAX}_{_}_{PROJECTED}, or (ii) may indicate that the planned runway procedure should be abandoned. For example, in an embodiment, controller 12 may generating a notification indicating one or more manners in which the planned runway procedure can be modified if determining that the runway procedure can, in fact, be successfully modified to reduce TS_{MAX}_{_}_{PROJECTED} to a value equal to or less than TS_{LIMIT}. Conversely, controller 12 may generate an instruction or recommendation to abort the planned runway procedure if instead determining that the planned runway procedure cannot be modified to reduce TS_{MAX}_{_}_{PROJECTED} to a value equal to or less than TS_{LIMIT}. For example, as indicated in FIG. 3, such an instruction to abort may be presented as a text annunciation “GO AROUND” contained within text box 70. In the case of a landing procedure, such a recommendation may be warranted to decrease the gross weight of ownship A/C through additional fuel burn and/or when high tailwinds are present and should soon dissipate. Other corrective actions or runway procedure modifications potentially suggested in conjunction with generation of overspeed warning alert 68 include alterations to maneuver limits and/or alterations to the landing or takeoff configurations of the ownship A/C.

After STEP 52, the present iteration of prognostic tire overspeed algorithm 40 concludes (STEP 58, FIG. 2). Additional iterations of prognostic tire overspeed algorithm 40 may then be performed, as desired, to continually assess the likelihood of tire overspeed events with shifting surface wind conditions and other dynamic factors. If controller 12 instead determines that T_{MAX}_{_}_{PROJECTED} is equal to or less than T_{LIMIT} during STEP 50 (FIG. 2), controller 12 advances to STEP 54 of prognostic tire overspeed algorithm 40 (FIG. 2). During STEP 54, controller 12 determines whether T_{MAX}_{_}_{PROJECTED} exceeds T_{LIMIT} less a predetermined safety margin, which may be a static or dynamic value. The safety margin can be expressed as, for example, predetermined rotational rate differential (e.g., 1 to 2 degrees per second) or a percentage of T_{LIMIT}; e.g., in one embodiment, controller 12 may determine whether T_{MAX}_{_}_{PROJECTED} exceeds (0.95)T_{LIMIT} during STEP 48. If answering the query at STEP 54 in the negative, controller 12 continues onward to STEP 58 and the present iteration of algorithm 40 concludes. Conversely, if T_{MAX}_{_}_{PROJECTED} exceeds T_{LIMIT} less the safety margin, controller 12 advances to STEP 56 and generates a low level caution alert, such as a visual alert of the type described below in conjunction with FIG. 4.

FIG. 4 illustrates a vertical navigation display 72 on which controller 12 may generate a low level caution alert during STEP 56 of prognostic tire overspeed algorithm 40 (FIG. 2). In this example, the ownship A/C (represented by symbol 74) is approaching a runway (represented by symbol 76) for landing along a current trajectory profile 78. In accordance with STEPS 54, 56 of prognostic tire overspeed algorithm 40 (FIG. 2), controller 12 has determined that a low level caution alert 80 is appropriately generated on vertical navigation display 72. As was the case previously, tire overspeed caution alert 80 includes a text annunciation in a text box 82 (in this example, the annunciation cautioning that a “TIRE OVERSPEED [event is] LIKELY”). Additionally, as indicated in FIG. 4 by a second cross-hatch pattern, text box 82 is filled with a predetermined caution color, such as yellow or amber. In conjunction with generation of tire overspeed caution alert 80, controller 12 has also generated a corrective modifications to the planned landing procedure to reduce TS_{MAX}_{_}_{PROJECTED}. This suggested modification is presented as a text annunciation appearing in text box 84 and advising the pilot to “ADJUST DRAG DEVICE DEPLOYMENT.” If desired, graphics may be further presented on vertical navigation display 72 visually indicating one or more suggested manners in which the drag device deployment timing may be adjusted for the ownship A/C to capture an alternative trajectory profile 86 reducing T_{MAX}_{_}_{PROJECTED}. For example, as indicated in FIG. 4, a number of drag device deployment markers or cues 88, 90 are also presented on vertical navigation display 72. In this example, deployment cues 88, 90 include an airbrake deployment cue 88 and a first flap deployment cue 90. After generating the tire overspeed caution alert at STEP 56, controller 12 then advances to STEP 58 at which the present iteration of prognostic tire overspeed algorithm 40 concludes. Further iterations of prognostic tire overspeed algorithm 40 may then be performed, as desired.

There has thus been provided embodiments of avionic systems and methods for forecasting and reducing the likelihood of tire overspeed events during aircraft runway procedures. In certain embodiments, the avionic system may also generate a tire speed status graphic, which provides additional information relating to the predicted imminence and occurrence of tire overspeed events, on a graphical display of the ownship A/C. Consider, for example, FIG. 5 illustrating a first exemplary tire speed status graphic 92. In this particular example, tire speed status graphic 92 is generated as a generally circular frame or bezel surrounding a central Attitude Indicator (ADI) window 93, which indicates the current pitch of the ownship A/C in the well-known manner. Tire speed status graphic 92 further includes an outer arc-shaped time scale 94 graduated in seconds, as well as an inner arc-shaped rate scale 96 graduated in a rotation rate (e.g., degrees of rotation per second). An arc-shaped bar or line 98 is generated in time scale 94 and denotes elapsed time (in seconds) since initiation of the A/C rotation. Three markers 100, 102, 104 are further generated on inner rate scale 96. Marker 100 designates TS_{LIMIT}, marker 102 designates the standard operating procedure (SOP) limit for the rotation rate, and marker 104 designates an estimated tail strike rotation limit.

FIG. 6 illustrates a second exemplary tire speed status graphic 106, which may be produced as a part of a tire synoptic page in an embodiment. Tire speed status graphic 106 can be generated on any suitable cockpit systems tire synoptic display. A text annunciation 108 is produced in the upper left corner of graphic 106 specifying TS_{LIMIT}, which is 225 MPH in the present example. Numerical readouts indicating actual tire speed (TS_{ACTUAL}) are expressed within aft left tire symbols 110, 112 and aft right tire symbols 114, 116. Additional tire speed readouts may also be produced in forward tire symbols 118, 120; however, as indicated by the text label “AIR” in FIG. 6, the forward landing gear is currently airborne such that tire speed readouts are not produced in tire symbols 118, 120. In this embodiment, a color coding scheme is utilized to denote whether the TS_{ACTUAL} value associated with each A/C tire falls within a normal operation range, approaches TS_{LIMIT}, or is presently exceeding TS_{LIMIT}. This may be appreciated by comparing the numerical readout in tire symbol 110, which is well-below the TS_{LIMIT} value of 225 MPH and which is consequently color coded to an information color (e.g., green or white, as indicated in FIG. 6 by a first cross-hatch pattern); to the readouts in tire symbols 112, 114, which are approaching the TS_{LIMIT} value and which are consequently color coded to a caution color (e.g., amber, as indicated by a second cross-hatch pattern); and the readouts in tire symbol 116, which has exceeded the TS_{LIMIT} value and which is consequently color coded to a warning color (e.g., red, as indicated by a third cross-hatch pattern). Additionally, a graphic 122 (e.g., a text annunciation) is produced adjacent tire symbol 116, which represents the A/C tire for which an overspeed event has occurred. In this example, graphic 122 provides a running tally of the total number of overspeed events to which the associated A/C tire has been subjected. In further embodiments, graphic 122 may visually express other tire overspeed information, such as the severity and/or the cumulative duration of the tire overspeed events to which the A/C tire or tires have been subjected.

In embodiments wherein TS_{ACTUAL} is monitored and tire speed events are recorded upon occurrence, avionic system 10 (FIG. 1) may also transmit certain related information to a remote source for maintenance scheduling purposes. For example, upon occurrence of a tire overspeed event, controller 12 may transmit information pertaining to the tire overspeed event to ATC 34 via datalink subsystem 26. ATC 34 may then forward the relevant information to a maintenance center. Alternatively, avionic system 10 (FIG. 1) may directly transmit such information to a remotely-located maintenance center. Additionally or alternatively, such information regarding the occurrence of tire overspeed events can be automatically logged in a dedicated maintenance memory, which is onboard the A/C and which is accessed by maintenance personnel during A/C maintenance. Further emphasizing this point, and referring briefly once again to FIG. 1, avionic system 10 is illustrated as further including a maintenance memory 124. Maintenance memory 124 can be included in an CMC onboard the ownship A/C in an embodiment, which also stores other maintenance data pertaining to the ownship A/C. In another embodiment, and as further indicated in FIG. 1, maintenance memory 124 can be included in an active or passive RFID module 126, which is mounted to or adjacent the landing gear carrying the A/C tires. When the ownship A/C is grounded, maintenance memory 124 may be readily accessed by maintenance personnel located on the ground and equipped with an RFID scanner. By virtue of this approach, maintenance personnel located on the ground beneath the ownship A/C need only approach the A/C landing gear and transmit an interrogation signal to the RFID tag utilizing the RFID scanner. RIFD module 126 then returns the tire overspeed data stored in memory 124, which may then be utilized to determine whether one or more A/C tires should be subject to an enhanced inspection and potentially replaced ahead of schedule.

There has thus been provided embodiments of avionic systems and methods for forecasting and reducing the likelihood of tire overspeed events during aircraft runway procedures. In embodiments of the systems and method described herein, a predictive algorithm is carried-out by a flight deck display system ahead of a runway procedure. When performed, the predictive algorithm projects a maximum tire speed (TS_{MAX}_{_}_{PROJECTED}) during the planned runway procedure and then compares the predicted maximum tire speed to the maximum speed rating (TS_{LIMIT}) to predict the likelihood of the occurrence of a tire overspeed event (TS_{MAX}_{_}_{PROJECTED}>TS_{LIMIT}). If a tire overspeed event is predicted to occur within a certain confidence threshold, a warning message is generated. Suggestions for reducing the likelihood of a tire overspeed event may also be provided along with the warning message. This allows the pilot, other pilot member, or other personnel member to revise the parameters of the planned takeoff or landing procedure to reduce or eliminate the likelihood the tire overspeed event. In this manner, tire overspeed events can be preempted to better preserve the integrity of the A/C tire structure and thereby increase safety, while reducing operating and maintenance costs. Additionally, in certain embodiments, unique manners in which to visually express parameters relating to the predicted imminence and occurrence of tire overspeed events (e.g., TS_{LIMIT} and TS_{ACTUAL} values) on a display screen of the flight deck display system are also provided.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. Various changes may be made in the function and arrangement of elements described in an exemplary embodiment without departing from the scope of the invention as set-forth in the appended Claims.

What is claimed is:

1. An avionic system for deployment onboard an ownship aircraft (A/C) having A/C tires, the avionic system comprising:
at least one runway procedure data source; and
a controller operably coupled to the at least one runway procedure data source, the controller configured to:
receive runway procedure data from the at least one runway procedure data source pertaining to a planned runway procedure for the ownship A/C;
utilize the runway procedure data to project a maximum tire speed during the planned runway procedure (TS_{MAX}_{_}_{PROJECTED});
compare TS_{MAX}_{_}_{PROJECTED} to a maximum speed limit of the A/C tires (TS_{LIMIT}); and
generate a first alert indicating that a tire overspeed event is predicted to occur during the planned runway procedure if TS_{MAX}_{_}_{PROJECTED} exceeds TS_{LIMIT}.

2. The avionic system of claim 1 further comprising a display screen operably coupled to the controller, the controller configured to generate the first alert as a visual alert on the display screen if TS_{MAX}_{_}_{PROJECTED} exceeds TS_{LIMIT}.

3. The avionic system of claim 2 wherein the controller is further configured to generate, on the display screen, at least one suggested modification to the planned runway procedure to reduce TS_{MAX}_{_}_{PROJECTED} if TS_{MAX}_{_}_{PROJECTED} exceeds TS_{LIMIT}.

4. The avionic system of claim 2 wherein the controller is further configured to generate a second alert on the display screen if TS_{MAX}_{_}_{PROJECTED} is equal to or less than TS_{LIMIT}, while TS_{MAX}_{_}_{PROJECTED} exceeds TS_{LIMIT} less a safety margin.

5. The avionic system of claim 1 wherein, if TS_{MAX}_{_}_{PROJECTED} exceeds TS_{LIMIT}, the controller is further configured to:
if determining that the planned runway procedure can be modified in at least one manner to reduce TS_{MAX}_{_}_{PROJECTED} to a value equal to or less than TS_{LIMIT}, generate a notification expressing the at least one manner in which the planned runway procedure can be modified; and
if determining that the planned runway procedure cannot be modified to reduce TS_{MAX}_{_}_{PROJECTED} to a value equal to or less than TS_{LIMIT}, generate an instruction to abort the planned runway procedure.

6. The avionic system of claim 1 wherein, if TS_{MAX}_{_}_{PROJECTED} exceeds TS_{LIMIT}, the controller is further configured to:
forecast a severity of the predicted tire overspeed event; and
generate the first alert to indicate the forecasted severity of the predicted tire overspeed event.

7. The avionic system of claim 1 further comprising a display screen to which the controller is operably coupled, the controller further configured to generate a tire speed graphic on the display screen visually indicating TS_{MAX}_{_}_{PROJECTED}.

8. The avionic system of claim 7 wherein the controller is further configured to:
monitor a speed of the A/C tires during the planned takeoff procedure (TS_{ACTUAL}); and
generate a notification on the display screen if TS_{ACTUAL} exceeds TS_{LIMIT} during the takeoff procedure.

9. The avionic system of claim 7 wherein the controller is further configured to display device a speed of the A/C tires during the planned takeoff procedure (TS_{ACTUAL}).

10. The avionic system of claim 9 wherein the controller is configured to generate the tire speed graphic to include a tire speed meter and a marker, which is moved relative to the tire speed meter to denote an estimated tail strike rotation limit of the ownship A/C.

11. The avionic system of claim 1 further comprising a memory coupled to the controller, the controller further configured to:
display a monitored speed of the A/C tires during the planned takeoff procedure (TS_{ACTUAL}); and
if TS_{ACTUAL} exceeds TS_{LIMIT} during the takeoff procedure, create a log in the memory noting that a tire overspeed event has occurred and indicating a severity of the tire overspeed event.

12. The avionic system of claim 11 further comprising a radio frequency identification module containing the memory and mounted to the ownship A/C at a location proximate the A/C tires.

13. The avionic system of claim 1 wherein the at least one runway procedure data source comprises a flight management system configured to receive pilot input data describing the planned runway procedure.

14. An avionic system for deployment onboard an ownship aircraft equipped with aircraft tires having a maximum speed limit, the avionic system comprising:
a display device;
a pilot input interface; and
a controller operably coupled to the display device and to the pilot input interface, the controller configured to:
receive pilot-entered data via the pilot input interface describing planned runway procedures for the ownship aircraft;
project maximum tire speeds of the aircraft tires during the planned runway procedures utilizing the pilot-entered data; and
selectively generate visual notifications on the display device indicative of forecasted tire overspeed events based, at least in part, on the projected maximum tire speeds and the maximum speed limit of the aircraft tires.

15. The avionic system of claim 14 wherein the pilot input interface comprises a Flight Management System (FMS), and wherein the controller is configured to receive the pilot-entered data as takeoff and landing data entered into the FMS.

16. The avionic system of claim 14 wherein the controller is configured to selectively generate the visual notifications as visual alerts, which are graded based on the predicted likelihood of the forecasted tire overspeed events, the predicted severities of the the forecasted tire overspeed events, or a combination thereof.

17. A method carried-out by the controller of an avionic system associated with an aircraft (A/C) having A/C tires, the method comprising:
receiving runway procedure data describing a planned runway procedure for the A/C;
utilizing the runway procedure data to project a maximum tire speed during the planned runway procedure (TS_{MAX}_{_}_{PROJECTED});
comparing TS_{MAX}_{_}_{PROJECTED} to a maximum speed limit of the A/C tires (TS_{LIMIT}); and
if TS_{MAX}_{_}_{PROJECTED} exceeds TS_{LIMIT}, generating a first alert indicating that a tire overspeed event is predicted to occur during the planned runway procedure.

18. The method of claim 17 wherein receiving runway procedure data comprises receiving the runway procedure data as takeoff and landing data entered into a flight management system coupled to the controller.

19. The method of claim 17 further comprising:
if TS_{MAX}_{_}_{PROJECTED} exceeds TS_{LIMIT}, determining at least a first suggested corrective action reducing TS_{MAX}_{_}_{PROJECTED}; and
presenting the first suggested corrective action on a display screen of the avionic system when generating the first alert.

20. The method of claim 17 further comprising generating the first alert to indicate a forecasted severity of the predicted tire overspeed event.
